(19) United States
(12) Patent Application Publication
(10) Pub. No.: US 2017/0038233 A1
(43) Pub. Date: Feb. 9, 2017

(54) FLUID-FLOW MONITOR

(71) Applicant: LEEO, INC., Palo Alto, CA (US)

(72) Inventors: Nina S. Joshi, Saratoga, CA (US); Andrew G. Stevens, New York, NY (US)

(21) Appl. No.: 15/331,119

(22) Filed: Oct. 21, 2016

Related U.S. Application Data
(63) Continuation of application No. 14/470,525, filed on Aug. 27, 2014, now abandoned.

(51) Int. Cl. G01F 1/00; G01F 15/18

(52) U.S. Cl. CPC G01F 1/00; G01F 15/18

(57) ABSTRACT

An electronic device that monitors flow of a fluid in a vessel (such as a pipe) is described. This electronic device may be mounted on an exterior of the vessel using a mounting mechanism. For example, the mounting mechanism may be attached to the vessel using a clamp, and an impedance-matching material may provide mechanical coupling to the vessel. Moreover, during operation a sensor mechanism in the electronic device may measure flow of the fluid, and an integrated circuit in the electronic device may analyze the flow measurements. In particular, the sensor mechanism may measure flow using non-invasive techniques (e.g., using an ultrasound transducer, an acoustic sensor or a vibration sensor) without contact with the fluid. The sensor mechanism may also facilitate the analysis by determining an orientation of the sensor mechanism relative to a reference direction and/or a cross-sectional area of the flow.

### BACKGROUND

Field

The described embodiments relate generally to an electronic device for monitoring fluid flow in a vessel. More specifically, the described embodiments relate to techniques for monitoring fluid flow in a vessel using an electronic device with an integrated temperature sensor.

Related Art

Trends in connectivity and in portable electronic devices are resulting in dramatic changes in people's lives. For example, the Internet now allows individuals access to vast amounts of information, as well as the ability to identify and interact with individuals, organizations and companies around the world. This has resulted in a significant increase in online financial transactions (which are sometimes referred to as ‘ecommerce’). Similarly, the increasingly powerful computing and communication capabilities of portable electronic device (such as smartphones and tablets), as well as a large and growing set of applications, are accelerating these changes, providing individuals access to information at arbitrary locations and the ability to leverage this information to perform a wide variety of tasks.

Recently, it has been proposed these capabilities be included in other electronic devices that are located throughout our environments, including those that people interact with infrequently. In the so-called ‘Internet of things,’ it has been proposed that future versions of these so-called ‘background’ electronic devices be outfitted with more powerful computing capabilities and networking subsystems to facilitate wired or wireless communication. For example, the background electronic devices may include: a cellular network interface (LTE, etc.), a wireless local area network interface (e.g., a wireless network such as described in the Institute of Electrical and Electronics Engineers (IEEE) 802.11 standard or Bluetooth™ from the Bluetooth Special Interest Group of Kirkland, Wash.), and/or another type of wireless interface (such as a near-field-communication interface). These capabilities may allow the background electronic devices to be integrated into information networks, thereby further transforming people's lives.

However, the overwhelming majority of the existing background electronic devices in people's homes, offices and vehicles have neither enhanced computing capabilities (such as processor that can execute a wide variety of applications) nor networking subsystems. Given the economics of many market segments (such as the consumer market segment), these so-called ‘legacy’ background electronic devices (which are sometimes referred to as ‘legacy electronic devices’) are unlikely to be rapidly replaced.

These barriers to entry and change are obstacles to widely implementing the Internet of things. For example, in the absence of enhanced computing capabilities and/or networking subsystems it may be difficult to communicate with the legacy electronic devices. Furthermore, even when electronic devices include enhanced computing capabilities and/or networking subsystems, power consumption and battery life may limit the applications and tasks that can be performed.

### SUMMARY

The described embodiments relate to an electronic device that includes a mounting mechanism that mechanically couples to a vessel (such as a pipe or a wire) that conveys a fluid. Moreover, a sensor mechanism in the electronic device measures flow of the fluid in the vessel without contact with the fluid, and an integrated circuit in the electronic device analyzes the measurements.

Note that the mounting mechanism may be mechanically coupled to an exterior of the vessel. For example, the mounting mechanism may include a clamp. However, in some embodiments the mechanical coupling involves screwing the mounting mechanism into the vessel. Furthermore, the mounting mechanism may include a surface having an impedance-matching material (such as a gel) that mechanically couples to the vessel.

Additionally, the sensor mechanism may include: an ultrasound transducer, an acoustic transducer, an optical sensor, and an electrical sensor that detects of motion of electrically charged particles, a magnetic sensor that detects of motion of magnetic particles, a Hall-effect sensor, a vibration sensor, a sensor that measures a parameter that is a function of temperature, and/or a pressure sensor.

In some embodiments, the electronic device includes an analysis device that determines a composition of the fluid.

Moreover, the sensor mechanism may include multiple sensors that mechanically couple to the vessel along a contour. This contour may include: a cross-sectional contour that is approximately perpendicular to a symmetry axis of the vessel; a direction that is approximately parallel to a symmetry axis of the vessel; and/or a spiral contour having a symmetry axis that is approximately parallel to a symmetry axis of the vessel.

Alternatively or additionally, the electronic device may include an interface circuit that communicates with other instances of the electronic device that are mechanically coupled to the vessel. For example, the electronic device may be electrically coupled to the vessel, and the communication may occur via the vessel. Alternatively or additionally, the communication may occur via the fluid.

In some embodiments, the electronic device includes a power supply that receives and stores power based an the flow. For example, the power supply may include: a turbine, a power source based on vibration associated with the flow, a power source based on a temperature difference associated with the flow, a power source based on a flow of magnetic particles, and/or a power source based on a flow of electrically charged particles.

Note that the fluid may include: a liquid, a gas, an electrical current in a wire, packets of information in a communication channel, and/or discrete particles (such as capsules in a hyperloop or a pneumatic-tube delivery system). Moreover, the measured flow may include information specifying: a presence or absence of the flow, a direction of the flow, a speed of the flow, identification of the fluid, a material flux of the flow, measurement of the quality of a vacuum, and/or a presence or absence of turbulence.

Furthermore, the sensor mechanism may determine: an orientation of the sensor mechanism relative to a reference direction: and/or a cross-sectional area of the flow in the vessel.

Another embodiment provides a system with multiple instances of the electronic device (described above) that are mechanically coupled to the vessel that conveys the fluid at different positions on the vessel. One or more of the instances of the electronic device may communicate with each other using interface circuits. The communication may include information about flow measurements obtained by the one or more of the multiple instances of the electronic device.

Moreover, the integrated circuit in at least one of the instances of the electronic device may determine a relative order of a given instance of the electronic device and the one or more of the multiple instances of the electronic device based on the communication. The determined relative order may facilitate the analysis.

Furthermore, the integrated circuit may identify an error condition in the vessel based on: historical measurements of the flow; and/or information about flow measurements obtained by the one or more of the multiple instances of the electronic device. Note that the error condition may include: a partial blockage of the vessel, complete blockage of the vessel, a leak, unauthorized usage of the fluid, and/or a malfunctioning sensor mechanism.

Another embodiment provides the integrated circuit described above.

Another embodiment provides a method for measuring flow of the fluid in the vessel, which may be performed by the electronic device described above. During operation, the electronic device receives a wake signal from another instance of the electronic device at another position along the vessel when the other instance of the electronic device detects the presence of the flow. Then, the electronic device transitions from a low-power state to a higher power state based on the received wake signal. Moreover, the electronic device measures the flow using the sensor mechanism in the electronic device. Next, the electronic device analyzes the measurements using the integrated circuit in the electronic device.

The preceding summary is provided as an overview of some exemplary embodiments and to provide a basic understanding of aspects of the subject matter described herein. Accordingly, the above-described features are merely examples and should not be construed as narrowing the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating a system in accordance with an embodiment of the present disclosure.

FIG. 2 is a block diagram illustrating an electronic device in the system of FIG. 1 in accordance with an embodiment of the present disclosure.

FIG. 3 is a block diagram of an integrated circuit in the electronic device of FIGS. 1 and 2 in accordance with an embodiment of the present disclosure.

FIG. 4 is a flow diagram illustrating a method for measuring flow of a fluid in a vessel in accordance with an embodiment of the present disclosure.

FIG. 5 is a drawing illustrating communication within the electronic device of FIGS. 1 and 2 during the method of FIG. 4 in accordance with an embodiment of the present disclosure.

FIG. 6 is a drawing illustrating measurement of a flow of a fluid in a vessel in accordance with an embodiment of the present disclosure.

FIG. 7 is a drawing illustrating measurement of a flow of a fluid in a vessel in accordance with an embodiment of the present disclosure.

FIG. 8 is a drawing illustrating measurement of a flow of a fluid in a vessel in accordance with an embodiment of the present disclosure.

FIG. 9 is a drawing illustrating measurement of a flow of a fluid in a vessel in accordance with an embodiment of the present disclosure.

FIG. 10 is a drawing illustrating measurement of a flow of a fluid in a vessel in accordance with an embodiment of the present disclosure.

FIG. 11 is a drawing illustrating measurement of a flow of a fluid in a vessel in accordance with an embodiment of the present disclosure.

FIG. 12 is a drawing illustrating measurement of a flow of a fluid in a vessel in accordance with an embodiment of the present disclosure.

FIG. 13 is a drawing illustrating measurement of a flow of a fluid in a vessel in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device that monitors flow of a fluid in a vessel (such as a pipe) is described. This electronic device may be mounted on an exterior of the vessel using a mounting mechanism. For example, the mounting mechanism may be attached to the vessel using a clamp, and an impedance-matching material may provide mechanical coupling to the vessel. Moreover, during operation a sensor mechanism in the electronic device may measure flow of the fluid, and an integrated circuit in the electronic device may analyze the flow measurements. In particular, the sensor mechanism may measure flow using non-invasive techniques (e.g., using an ultrasound transducer, an acoustic sensor or a vibration sensor) without contact with the fluid. The sensor mechanism may also facilitate the analysis by determining an orientation of the sensor mechanism relative to a reference direction and/or a cross-sectional area of the flow. Furthermore, the integrated circuit may analyze flow measurements provided by multiple instances of the electronic device at different locations on the vessel.

In this way, the electronic device may monitor the flow of the fluid in the vessel. This capability may facilitate a variety of services, such as monitoring the use of water or sewage systems in a building with multiple occupants (such as an apartment building). In addition, the electronic device may represent an environmental monitoring device that: can be deployed or installed rapidly (with low cost and limited effort), may have improved operating life e.g., increased battery life between recharging or replacement of a battery), and may be easy to use. Thus, the electronic device may provide a compact and low-cost way to monitor an environmental condition in an external environment that includes the electronic device. The resulting improved functionality and services offered by the electronic device may promote sales of the electronic device (and, more generally, commercial activity) and may enhance customer satisfaction with the electronic device.

Note that this environmental-monitoring technique is not an abstract idea. In particular, the monitoring of the flow of the fluid included in embodiments of the environmental-monitoring technique is not; a fundamental economic principle, a human activity (the operations in the environmental-monitoring technique typically involve measurements in noisy environments), and/or a mathematical relationship/formula. Moreover, the environmental-monitoring technique amounts to significantly more than an alleged abstract idea, in particular, the environmental-monitoring technique may improve the functioning of the electronic device that executes software and/or implements the environmental-monitoring technique. For example, the environmental-monitoring technique may: speed up computations performed during the environmental-monitoring technique; reduce memory consumption when performing the computations; improve reliability of the computations (as evidenced, by improved monitoring of the flow); improve the user-friendliness of a user interface that displays results of the measurements (e.g., by allowing a user to view information about environmental condition in the external environment of the electronic device); and/or improve other performance metrics related to the function of the electronic device. Furthermore, the measurements performed by the sensor mechanism in the electronic device constitute a technical effect in which information is transformed.

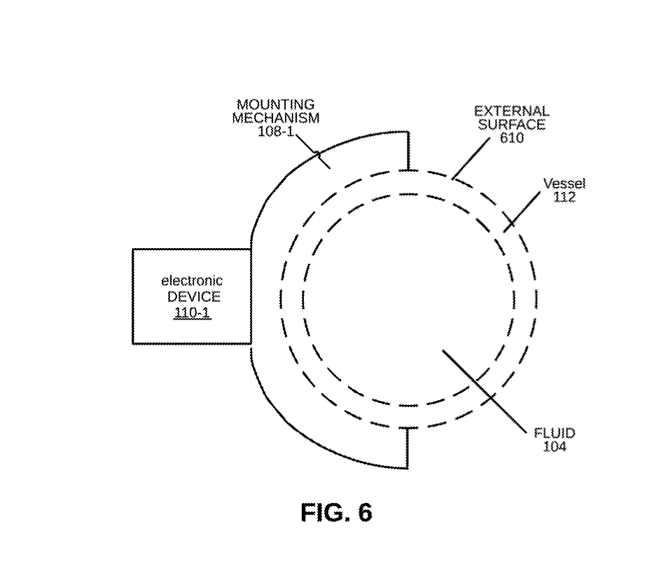

We now describe embodiments of the electronic device. FIG. presents a block diagram illustrating electronic devices 110 in a system 100. This system includes a vessel 112 (such as a pipe, an enclosed conduit or a container) that conveys a fluid 104. Fluid 104 may include: a liquid, a gas, and/or discrete particles (such as grain, sand, mold, beads, sugar, flour, capsules or payloads in a hyperloop or a pneumatic-tube delivery system, etc.). One or more electronic devices 110 may be mechanically coupled to vessel 112. As described further below with reference to FIG. 6, this mechanically coupling may be to an exterior of vessel 112. For example, the one or more electronic devices 110 may include at least a portion of or may be coupled to mounting mechanisms 108, such as: a clamp, a cable tie, adhesive tape, a wrap-around material, etc. Consequently, there may not be direct contact between the one or more electronic devices 110 (and, in particular, sensor mechanisms, such as sensor mechanism 114-1, in the one or more electronic devices 110) and fluid 104.

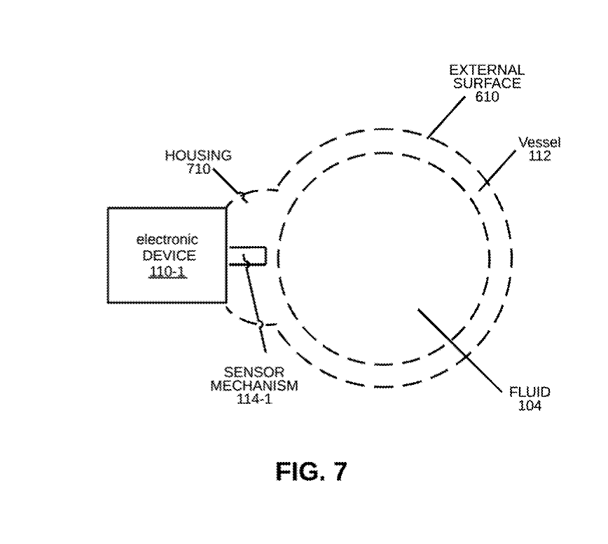

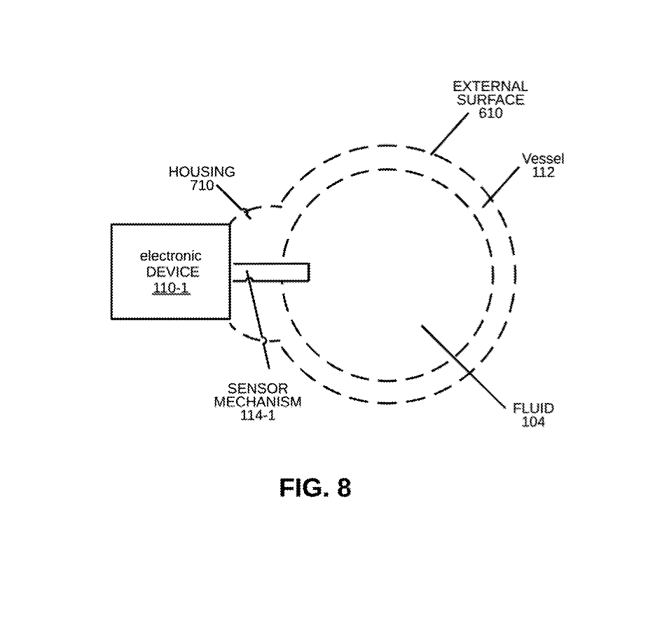

Alternatively, as described further below with reference to FIGS. 7 and 8, the one or more electronic devices 110 may, at least in part, be mounted into vessel 112 (i.e., invasively attached through a wall of vessel 112). For example, the one or more electronic devices 110 may be screwed into vessel 112. This may allow the sensor mechanisms to directly contact fluid 104. Note that the mechanical coupling or mounting of the one or more electronic devices 110 on vessel 112 may be remateable or may involve rigid coupling that is not easily reversed (such as solder or a weld).

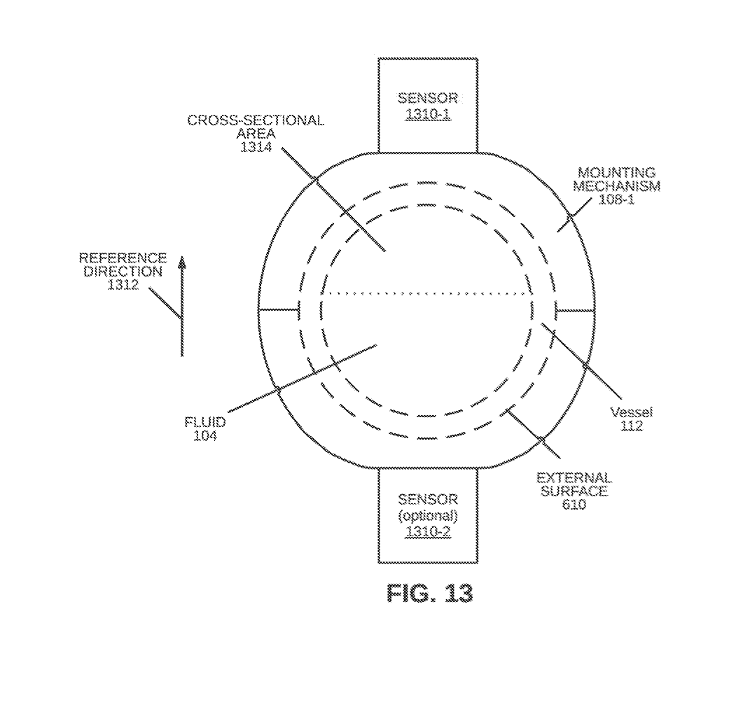

The one or more electronic devices 110 may monitor flow 106 of fluid 104 in vessel 112. Using electronic device 110-1 as an example, sensor mechanism 114-1 may measure flow 106 of fluid 104 in vessel 112, in particular, sensor mechanism 114-1 may use a non-invasive technique (e.g., without contact with fluid 104) and/or an invasive technique (e.g., with contact with fluid 104) to determine information about flow 106 specifying: a presence or absence of flow 106, a direction of flow 106, a speed of flow 106, identification of fluid 104 (such as the composition), a material flux of flow 106 (e.g., based on machine vision of an outlet from vessel 112), measurement of the quality of a vacuum, and/or a presence or absence of turbulence. As described further below with reference to FIG. 13, measurement of flow 106 may involve sensor mechanism 114-1 determining: an orientation of sensor mechanism 114-1 relative to a reference direction (such as a ‘vertical’ direction relative to the ground); and/or a cross-sectional area of flow 106 in vessel 112 (which may allow the flux to be calculated).

Thus, a wide variety of sensors based on different physical principles may be used in sensor mechanism 114-1 to measure flow 106, including: an ultrasound transducer, an acoustic transducer, an optical sensor, and an electrical sensor that detects of motion of electrically charged particles, a magnetic sensor that detects of motion of magnetic particles, a Hall-effect sensor, a vibration sensor, a sensor that measures a parameter that is a function of temperature (such as that of fluid 104), and/or a pressure sensor (such as a manometer or a Venturimeter). In some embodiments, such as those where sensor mechanism 114-1 is based on measurements of waves (e.g., waves having wavelengths in an acoustic band or an ultrasound band, or waves associated with vibrations) or pressure in vessel 112, mounting mechanisms 108 may include an inner surface (facing vessel 112) having an impedance-matching material (such as a gel) that mechanically couples to vessel 112. Similarly, measurements of the parameter that is a function of temperature may be facilitated by a thermal interface material (such as a thermal paste, grease or solder) on the inner surface of mounting mechanisms 108, which thermally couples to vessel 112. Note that measurements of the parameter may be direct (such as by using a: thermometer, a calibrated resistor, a silicon-bandgap temperature sensor, a metal-oxide-semiconductor field-effect transistor, a thermistor, a thermocouple, a thermopile, a temperature sensor based on an electrothermal filter, etc.) or indirect (such as by using a: a calorimeter, a sensor that measures a physical phenomenon that is a function of temperature, e.g., thermal expansion, a chemical sensor that monitors a temperature-dependent chemical reaction, e.g., adhesion or a gas or a compound that reacts with the material, a circuit that measures a temperature-dependent frequency and/or phase of a signal, etc.).

One or more of the one or more electronic devices 110 may analyze the measurements. For example, electronic device 110-1 may include an integrated circuit 116-1 that analyzes the measurements (e.g., electrical signals) from sensor mechanism 114-1. This analysis may include: filtering (such as with a low-pass filter or a band-pass filter) that removes noise from the electrical signals and, more generally, spectral shaping. In addition, the analysis may include measurements and/or detection using: a voltmeter, an ammeter, a phase detector, a resonance monitor, a Fourier analyzer, a spectrum analyzer, a lock-in amplifier (which may be synchronized to a time varying electrical signal having a fundamental frequency that corresponds to pressure waves in vessel 112), an averaging circuit (that averages multiple measurements of an electrical signal), a heterodyne receiver (and, more generally, a demodulator), and/or another measurement device that measures or captures one or more instances of an electrical signal. Thus, the analysis performed by integrated circuit 116-1 may include synchronous or asynchronous detection.

In some embodiments, the analysis is based on predefined information. In particular, the predefined information (such as a conversion from the parameter to a temperature in vessel 112) may be obtained locally (on electronic device 110-1) using a stored look-up or conversion table. Alternatively or additionally, an interface circuit 120-1 (or a network interface) in electronic device 110-1 may access the predefined information remotely, such as from optional computer 126 via optional network 124 (such as the Internet, a wireless local area network, an Ethernet network, an intra-net, an optical network, etc.). Thus, the analysis may include converting the measured parameter into a temperature using a look-up or conversion table that summarizes values of the parameter and corresponding temperatures. For example, a resistance of sensor mechanism 114-1 may be converted into the temperature. Similarly, the analysis may include converting measurements into magnitude and/or direction of flow 106 using another look-up or conversion table that summarizes values of the electrical signal and corresponding flow values and signs (e.g., based on the Bernoulli equation for vessel 112 and, more generally, based on predetermined analysis of vessel 112, such as the Reynolds number for a portion of vessel 112). Note that flow 106 may be determined relative to a threshold value (such as a flow increase relative to an initial flow of more than 1 m/s or more than 0.5 kg·m/s). Thus, measurements of flow 106 may be compared to the threshold value, and a binary output may be calculated (e.g., a ‘0’ may be less than the threshold value and a ‘1’ may be greater than the threshold value). Alternatively, the absolute flow (such as the volume flow rate, the weight flow weight, the mass flow rate and/or a flow metric) may be determined with an accuracy (such as 0.1, 1, 2 or 5 m/s or 0.1, 1,2, or 5 kg/s) over a range of flow values. In these ways, the environmental condition (which may include the specified information described above and/or which may be a function of or depend on the specified information, such as a vacuum in vessel 112) in vessel 112 (and, more generally, in external environment 128) may be determined.

In some embodiments, electronic device 110-1 includes an optional analysis device 118-1 that determines a composition of fluid 104 (which may include determining a chemical purity of fluid 104). As with the flow measurements, the composition may be determined directly or indirectly. For example, the composition may be determined using chemical analysis (such as gas chromatography, liquid chromatography, ion microprobe, electrophoresis, cyclic voltammetry, etc.) and/or microanalysis (such as x-ray diffraction, x-ray florescence spectroscopy, Raman spectroscopy, infrared spectroscopy, mass spectrometry, energy dispersive spectroscopy, Fourier transform spectroscopy, nuclear magnetic resonance, electron paramagnetic resonance, calorimetry, absorption spectroscopy, emission spectroscopy, etc.). Alternatively or additionally, sensor mechanism 114-1 and/or optional analysis device 118-1 may determine the age, composition and/or damage to vessel 112. For example, an active transducer (such as ultrasound) may allow optional analysis device 118-1 to assess damage or aging of vessel 112, while optional analysis device 118-1 may use chemical analysis and/or microanalysis to assess any damage or aging of vessel 112.

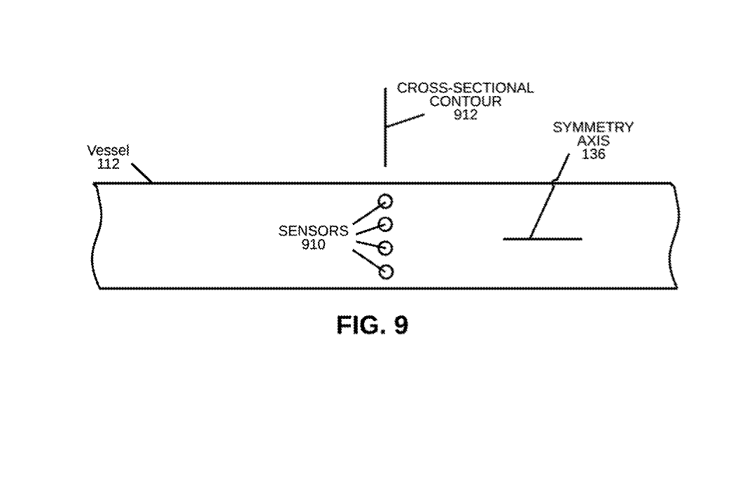

Furthermore, when there are multiple instances of electronic devices 110 at different positions 134 along vessel 112, the analysis of the measurements by one or more of electronic devices 110 may use measurements performed by the sensor mechanisms in two or more of electronic devices 110. For example, an interface circuit in electronic device 110-2 may communicate the measurements with interface circuit 120-1. This communication may involve wireless communication of packets. These packets may be included in frames in one or more wireless channels. Consequently, the interface circuits may include radios (such as radio 130-1) that transmit wireless signals 132 (illustrated by jagged lines) to one or more other electronic devices 110, where they are received by an instance of the radio. In general, the wireless communication between electronic devices 110 may or may not involve a connection being established among these electronic devices, and therefore may or may not involve communication via a wireless network. Alternatively or additionally, as described further below with reference to FIGS. 9-11, sensor mechanism 114-1 may include multiple sensors at different positions along vessel 112, which communicate measurements to interface circuit 120-1 via wireless signals 132 or wired communication. Furthermore, in some embodiments the communication may occur via vessel 112 (such as when vessel 112 conducts electricity). In these embodiments, mounting mechanisms 108 in or coupled to electronic devices 110 may electrically couple the inner surfaces to vessel 112 (e.g., using an electrically conductive paste, gel or solder). However, in some embodiments the communication occurs via flow 106 in vessel 112. Notably, a carrier wave (such as a vibration) in flow 106 having a fundamental frequency may convey information using encoding techniques such as: amplitude modulation, frequency modulation, phase modulation, pulse-code modulation, etc. In these embodiments, vessel 112 may not be a conductor.

As is also described further below with reference to FIGS. 9-11, multiple sensors for a given electronic device (such as electronic device 110-1) and/or multiple instances of electronic devices 110 may be coupled to vessel 112 along a contour (such as a cross-sectional contour that is approximately perpendicular to a symmetry axis 136 of vessel 112; a direction that is approximately parallel to symmetry axis 136 of vessel 112; and/or a spiral contour having a symmetry axis that is approximately parallel to symmetry axis 136 of vessel 112), and (as noted previously) measurements provided by these sensors and/or electronic devices may be used by at least one of electronic devices 110 when performing the analysis. For example, integrated circuit 116-1 may determine a relative order of electronic device 110-1 and one or more of the other instances of electronic devices 110 (or the sensors in sensor mechanism 114-1) based on the communication. The determined relative order may facilitate the analysis (e.g., by allowing unexpected changes in flow 106, such as those associated with a leak, to be detected). Furthermore, integrated circuit 116-1 may identify an error condition in vessel 112 based on: historical measurements of flow 106 (which may be obtained from optional computer 126 via optional network 124); and/or information about flow measurements obtained by the one or more electronic devices 110 (and/or the sensors in sensor mechanism 114-1). Note that the error condition may include: a partial blockage of vessel 112 (e.g., based on the presence of turbulent flow), complete blockage of vessel 112 (e.g., based on the absence of flow 106), a leak (e.g., loss or reduction of vacuum based on the deceleration of a particle), unauthorized usage of fluid 104, and/or a malfunctioning sensor mechanism (such as sensor mechanism 114-1).

In some embodiments, electronic device 110-1 includes a power supply 122-1 that receives and stores power based on flow 106. For example, power supply 122-1 may include: a turbine (or a kinetic-based power device), a power source based on vibration associated with flow 106, a power source based on a temperature difference associated with flow 106, a power source based on a flow of magnetic particles, and/or a power source based on a flow of electrically charged particles (such as an ionized gas). Note that in these embodiments, where power supply 122-1 receives and stores power from flow 106, the conveying of power via flow 106 is sometimes referred to as a ‘charging heartbeat.’

Power supply 122-1 may include a recharging circuit and a rechargeable battery (and, more generally, a device that includes one of more cells or battery packs, and that converts stored chemical energy into electricity), where the recharging circuit may recharge the rechargeable battery based on an electrical signal output by power supply 122-1 based on flow 106. Thus, flow 106 may be used (directly or indirectly) to power electronic device 110-1, thereby improving operating life or a time between recharges of the rechargeable battery. In some embodiments, the recharging circuit includes: a regulated power supply, a DC power supply, an AC power supply, a switched-mode power supply, etc. This may facilitate the recharging by converting the electrical signal from power supply 122-1 into a DC or an AC electrical signal that is suitable for recharging the rechargeable battery.

After determining the information about flow 106 and/or the error condition, electronic device 110-1 may use interface circuit 120-1 to communicate this information with one or more other electronic devices, such as electronic device 138 (which may be another instance of electronic device 110, a legacy electronic device, a user's cellular telephone, etc.). For example, electronic device 110-1 may wirelessly communicate packets with information specifying the determined information about flow 106 and/or the error condition to electronic device 138. These packets may be included in frames in one or more wireless channels. Consequently, electronic device 138 may be receive wireless signals 132 using radio 130-2. In general, the wireless communication between electronic devices 110 and 138 may or may not involve a connection being established among these electronic devices, and therefore may or may not involve communication via a wireless network. Note that the communication between optional computer 126 and electronic devices 110 via optional network 124 may involve a different communication protocol than that associated with wireless signals 132. Thus, the communication via optional network 124 may or may not involve wireless signals 132.

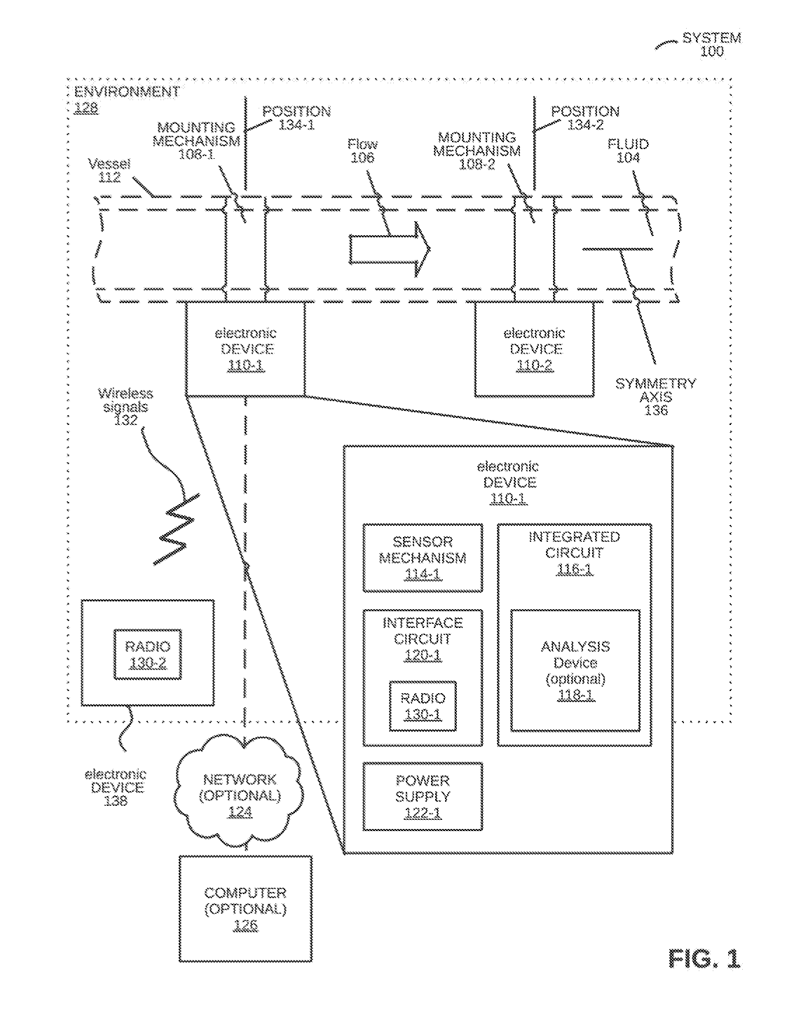

The determined information about flow 106, the error condition and/or the environmental condition (which may correspond to or may be related to flow 106) may facilitate a variety of services and improved functionality of the electronic devices in FIG. 1. For example, services may be offered to: users associated with electronic devices 110 and/or 138 (such as owners or renters of these electronic devices), suppliers of components or spare parts, maintenance personnel, security personnel, emergency service personnel, insurance companies, insurance brokers, realtors, leasing agents, apartment renters, hotel guests, hotels, restaurants, businesses, organizations, governments, potential buyers of physical objects, a shipping or transportation company, etc. In particular, the determined information about flow 106 and/or the error condition may allow the function or operation of one or more electronic devices in FIG. 1 (such as a legacy electronic device and/or a regulator device, which may or may not directly communicate information with electronic devices 110 and/or 138) to be adapted or changed. In this way, an environmental condition (such as usage of fluid 104, a flow rate, a maintenance condition of vessel 112, etc.) in vessel 128 may be dynamically modified. In addition, the service(s) may include maintenance notifications about vessel 112 and/or electronic devices 110. For example, based on the determined information about flow 106, electronic device 110 may provide a maintenance notification to a user's cellular telephone (e.g., via optional network 124) to perform a remedial action (such as a repair or service to be performed on vessel 112 or correcting unauthorized usage of fluid 104).

Although we describe the environment shown in FIG. 1 as an example, in alternative embodiments, different numbers or types of electronic devices may be present. For example, some embodiments comprise more or fewer electronic devices. Furthermore, while not shown in FIG. 1, one or more components in electronic device 112 may be coupled or connected by additional signals lines or a bus.

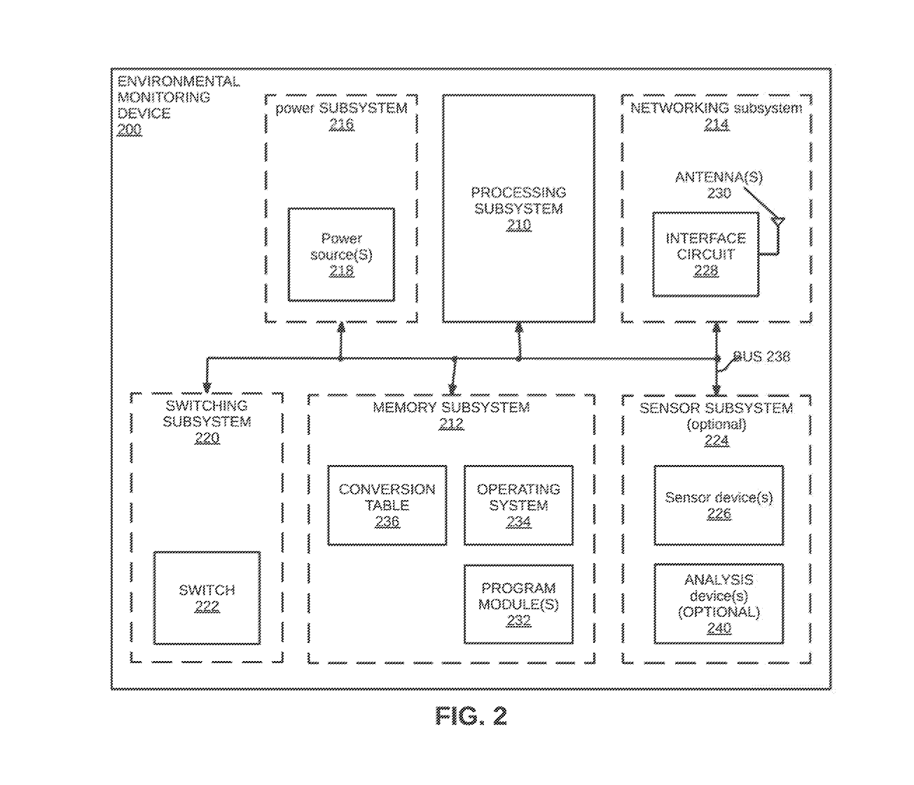

FIG. 2 presents a block diagram illustrating electronic device 200, which may be one of electronic devices 110 in FIG. 1. This electronic device includes processing subsystem 210 (and, more generally, an integrated circuit or a control mechanism), memory subsystem 212, a networking subsystem 214, power subsystem 216, switching subsystem 220 and optional sensor subsystem 224 (i.e., a data-collection subsystem and, more generally, a sensor mechanism). Processing subsystem 210 includes one or more devices configured to perform computational operations and to execute techniques to process sensor data. For example, processing subsystem 210 can include one or more microprocessors, application-specific integrated circuits (ASICs), microcontrollers, programmable-logic devices, and/or one or more digital signal processors (DSPs).

Memory subsystem 212 includes one or more devices for storing data and/or instructions for processing subsystem 210, networking subsystem 214 and/or optional sensor subsystem 224. For example, memory subsystem 212 can include dynamic random access memory (DRAM), static random access memory (SRAM), and/or other types of memory. Memory subsystem 212 may store one or more conversion tables 236 (such as a table with values of the parameter and the corresponding temperature or flow value). In some embodiments, instructions for processing subsystem 210 in memory subsystem 212 include: one or more program modules 232 or sets of instructions, which may be executed in an operating environment (such as operating system 234) by processing subsystem 210. Note that the one or more computer programs may constitute a computer-program mechanism or a program module. Moreover, instructions in the various modules in memory subsystem 212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 210.

In addition, memory subsystem 212 can include mechanisms for controlling access to the memory. In some embodiments, memory subsystem 212 includes a memory hierarchy that comprises one or more caches coupled to a memory in electronic device 200. In some of these embodiments, one or more of the caches is located in processing subsystem 210.

In some embodiments, memory subsystem 212 is coupled to one or more high-capacity mass-storage devices (not shown). For example, memory subsystem 212 can be coupled to a magnetic or optical drive, a solid-state drive, or another type of mass-storage device. In these embodiments, memory subsystem 212 can be used by electronic device 200 as fast-access storage for often-used data, while the mass-storage device is used to store less frequently used data.

Networking subsystem 214 includes one or more devices configured to couple to and communicate on a wired, optical and/or wireless network (i.e., to perform network operations and, more generally, communication), including an interface circuit 228 (such as a ZigBee® communication circuit) and one or more antennas 230. For example, networking subsystem 214 may include: a ZigBee® networking subsystem, a Bluetooth™ networking system (which can include Bluetooth™ Low Energy, BLE or Bluetooth™LE), a cellular networking system (e.g., a 3G/4G network such as (UMTS, LTE, etc.), a USB networking system, a networking system based on the standards described in IEEE 802.11 (e.g., a WiFi® networking system), an Ethernet networking system, an infra-red communication system, a power-line communication system and or another communication system (such as a near-field-communication system or an ad-hoc-network networking System).

Moreover, networking subsystem 214 includes processors, controllers, radios/antennas, sockets/plugs, and/or other devices used for coupling to, communicating on, and handling data and events for each supported networking or communication system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 200 may use the mechanisms in networking subsystem 214 for performing simple wireless communication between electronic device 200 and other electronic devices, e.g., transmitting advertising frames, petitions, beacons and/or information associated with near-field communication.

Moreover, electronic device 200 may include power subsystem 216 with one or more power sources 218. Each of these power sources may include: a battery (such as a rechargeable or a non-rechargeable battery), a DC power supply, a transformer, and/or a switched-mode power supply. Moreover, the one or more power sources 218 may operate in a voltage-limited mode or a current-limited mode. Furthermore, these power sources may be mechanically and electrically coupled by a male or female adaptor to: a wall or electrical-outlet socket or plug (such as a two or three-pronged electrical-outlet plug, which may be collapsible or retractable), a light socket (or light-bulb socket), electrical wiring (such as a multi-wire electrical terminal), a generator, a USB port or connector, a DC-power plug or socket, a cellular-telephone charger cable, a photodiode, a photovoltaic cell, etc. This mechanical and electrical coupling may be rigid or may be remateable. Note that the one or more power sources 218 may be mechanically and electrically coupled to an external power source or another electronic device by one of the electrical-connection nodes in switch 222 in switching subsystem 220.

In some embodiments, power subsystem 216 includes or functions as a pass-through power supply for one or more electrical connectors to an external electronic device (such as an appliance or a regulator device) that can be plugged into the one or more electrical connectors. Power to the one or more electrical connectors (and, thus, the external electronic device) may be controlled locally by processing subsystem 210, switching subsystem 220 (such as by switch 222), and/or remotely via networking subsystem 214.

In addition to sensor mechanism 114-1 (FIG. 1), optional sensor subsystem 224 may include one or more sensor devices 226 or a sensor array), which may include one or more processors and memory. For example, the one or more sensor devices 226 may include: a thermal sensor (such as a thermometer), a humidity sensor, a barometer, a camera or video recorder (such as a CCD or CMOS imaging sensor), one or more microphones (which may be able to record acoustic information, including acoustic information in an audio band of frequencies, in mono or stereo), a load-monitoring sensor or an electrical-characteristic detector (and, more generally, a sensor that monitors one or more electrical characteristics), an infrared sensor (which may be active or passive), a microscope, a particle detector (such as a detector of dander, pollen, dust, exhaust, etc.), an air-quality sensor, a particle sensor, an optical particle sensor, an ionization particle sensor, a smoke detector (such as an optical smoke detector or an ionizing smoke detector), a fire-detection sensor, a radon detector, a carbon-monoxide detector, a chemical sensor or detector, a volatile-organic-compound sensor, a combustible gas sensor, a chemical-analysis device, a mass spectrometer, a microanalysis device, a nano-plasmonic sensor, a genetic sensor (such as a micro-array), an accelerometer, a position or a location sensor (such as a location sensor based on the Global Positioning System or GPS), a gyroscope, a motion sensor (such as a light-beam sensor), a contact sensor, a strain sensor (such as a strain gauge), a proximity sensor, a microwave/radar sensor (which may be active or passive), an ultrasound sensor, a vibration sensor, a fluid flow sensor, a photo-detector, a Geiger counter, a radio-frequency radiation detector, and/or another device that measures a physical effect or that characterizes an environmental factor or physical phenomenon (either directly or indirectly). Note that the one or more sensor devices 226 may include redundancy (such as multiple instances of a type of sensor device) to address sensor failure or erroneous readings, to provide improved accuracy and/or to provide improved precision. In some embodiments, optional sensor subsystem 224 includes one or more optional analysis devices 240, which may determine a composition of the fluid in the vessel.

During operation of electronic device 200, processing subsystem 210 may execute one or more program modules 232, such as an environmental-monitoring application that uses one or more sensor devices 226 to monitor one or more environmental conditions in an external environment that includes electronic device 200, such as the flow in the vessel. The resulting sensor data may be used by the environmental-monitoring application to modify operation of electronic device and/or the external electronic device, and/or to provide information about the external environment to another (separate) electronic device (e.g., via networking subsystem 214). In addition, the environmental-monitoring application may use the one or more optional analysis devices 240 to determine the composition of the fluid and/or the vessel.

Moreover, electrical signals produced by power subsystem 216 in response to the flow in the vessel may be used to recharge one or more of power sources 218. For example, this power may, at least in part, offset or compensate for power loss (associated with one or more components in electronic device 200) during operation or a standby mode of electronic device 200 (which is sometimes referred to as a parasitic power loss).

After information about the flow and/or an error condition associated with the vessel has been determined, the environmental-monitoring application may share this information and/or information about an associated environmental condition with one or more other electronic devices via networking subsystem 214.

Within electronic device 200, processing subsystem 210, memory subsystem 212, networking subsystem 214, power subsystem 216, switching subsystem 220 and/or optional sensor subsystem 224 may be coupled using one or more interconnects, such as bus 238. These interconnects may include an electrical, optical, and/or electro-optical connection that the subsystems can use to communicate commands and data among one another. Note that different embodiments can include a different number or configuration of electrical, optical, and/or electro-optical connections among the subsystems.

Electronic device 200 can be (or can be included in) a wide variety of electronic devices. For example, electronic device 200 can be or can be included in): a sensor (such as a smart sensor), a tablet computer, a smartphone, a cellular telephone, an appliance, a regulator device, a consumer-electronic device (such as a baby monitor), a portable computing device, test equipment, a digital signal processor, a controller, a personal digital assistant, a laser printer (or other office equipment such as a photocopier), a personal organizer, a toy, a set-top box, a computing device (such as a laptop computer, a desktop computer, a server, and/or a subnotebook/netbook), a light (such as nightlight), an alarm, a smoke detector, a carbon-monoxide detector, a monitoring device, and/or another electronic device (such as a switch or a router).

Although specific components are used to describe electronic device 200, in alternative embodiments, different components and/or subsystems may be present in electronic device 200. For example, electronic device 200 may include one or more additional processing subsystems, memory subsystems, networking subsystems, power subsystems, switching subsystems, and/or sensor subsystems. Additionally, one or more of the subsystems may not be present in electronic device 200. Moreover, in some embodiments, electronic device 200 may include one or more additional subsystems that are not shown in FIG. 2, such as a user-interface subsystem, a display subsystem, and/or a feedback subsystem (which may include speakers and/or an optical source).

Although separate subsystems are shown in FIG. 2, in some embodiments, some or all of a given subsystem or component can be integrated into one or more of the other subsystems or components in electronic device 200. For example, in some embodiments the one or more program modules 232 are included in operating system 234. In some embodiments, a component in a given subsystem is included in a different subsystem.

Moreover, the circuits and components in electronic device 200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 214 (such as a radio) and, more generally, some or all of the functionality of electronic device 200. Moreover, the integrated circuit may include hardware and/or software mechanisms that are used for transmitting wireless signals from electronic device 200 to, and receiving, signals at electronic device 200 from other electronic devices. Aside from the mechanisms herein described, radios are generally known in the art and hence are not described in detail. In general, networking subsystem 214 and/or the integrated circuit can include any number of radios. Note that the radios in multiple-radio embodiments function in a similar way to the radios described in single-radio embodiments.

In some embodiments, networking subsystem 214 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, a petition, a beacon, etc.)

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both.

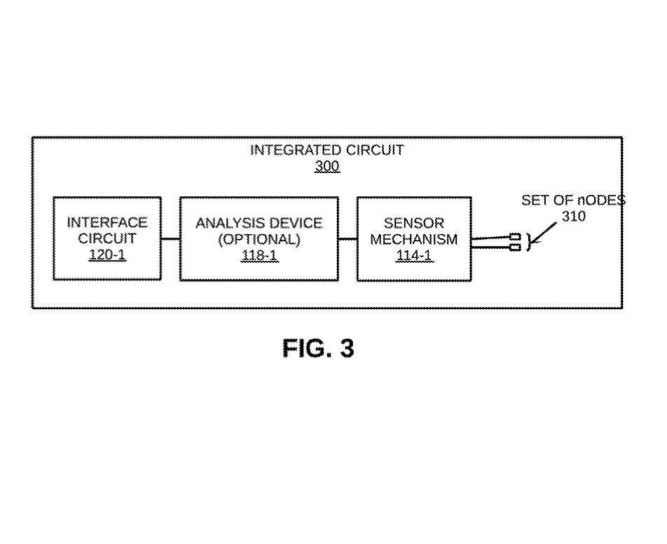

Aspects of the environmental-monitoring technique may be implemented using an integrated circuit. This is shown in FIG. 3, which presents a block diagram of integrated circuit 300 in electronic device 200 (FIG. 2). In particular, this integrated circuit may include: sensor mechanism 114-1 (such as one or more sensor devices 226 in FIG. 2); one or more input nodes 310 that electrically couple to other external components; optional analysis device 118-1 (or the one or more optional analysis devices 240 in FIG. 2) electrically coupled to sensor mechanism 114-1; and interface circuit 120-1 (or interface circuit 228 in FIG. 2).

In some embodiments, an output of a process for designing integrated circuit 300, or a portion of integrated circuit 300, which includes one or more of the circuits described herein may be a computer-readable medium such as, for example, a magnetic tape or an optical or magnetic disk. The computer-readable medium may be encoded with data structures or other information describing circuitry that may be physically instantiated as integrated circuit 300 or the portion of integrated circuit 300. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

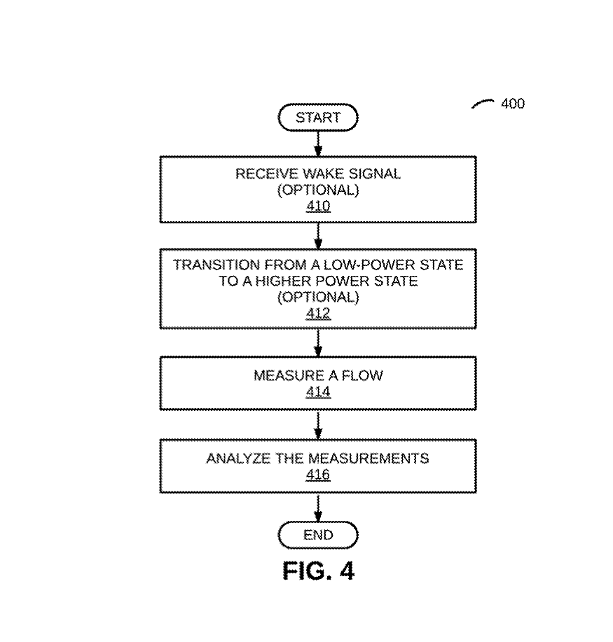

We now further describe the environmental-monitoring technique and operation of the electronic device. FIG. 4 presents a flow diagram illustrating a method 400 for measuring flow of a fluid in a vessel, which may be performed by one of electronic devices 110 (FIG. 1). During operation, the electronic device optionally receives a wake signal (operation 410) from another instance of the electronic device at another position along the vessel when the other instance of the electronic device detects the presence of the flow. Then, the electronic device optionally transitions from a low-power state to a higher power state (operation 412) based on the received wake signal. Moreover, the electronic device measures the flow (operation 414) using the sensor mechanism in the electronic device. Next, the electronic device analyzes the measurements (operation 416) using the integrated circuit in the electronic device.

In this way, multiple instances of the electronic device may be used to implement a wake-when-needed capability. In particular, the first sensor in a group of sensors (which may be associated with one electronic device or multiple electronic devices) may remain in an ‘on’ or higher power state (i.e., with higher power consumption, such as during normal operation), while a remainder of the group of sensors may be in a hibernation or low-power state. When the first sensor detects the flow, it may provide wake signals to one or more of the remaining sensors (and/or their associated electronic devices). Thus, this approach may reduce the power consumption of the electronic device(s).

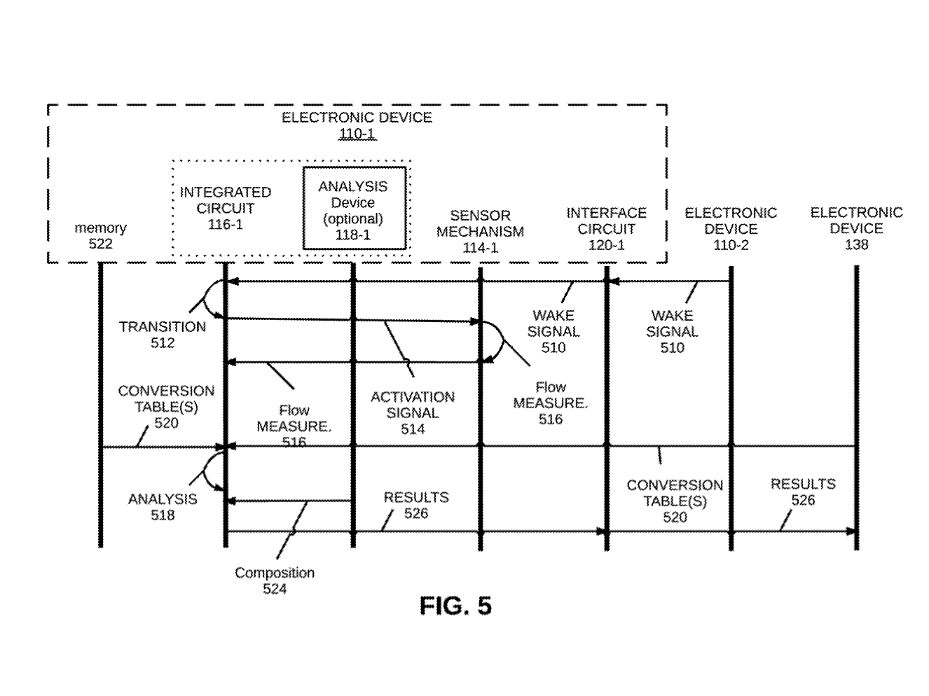

FIG. 5 presents a drawing illustrating communication within electronic device 110-1 (FIG. 1) during method 400 (FIG. 4). During operation of electronic device 110-1, interface circuit 120-1 optionally receives wake signal 510 from electronic device 110-2, which is transmitted by electronic device 110-2 when it detects the presence of a flow in a vessel. Then, interface circuit 120-1 optionally provides wake signal 510 to integrated circuit 116-1. In response, integrated circuit 116-1 optionally undergoes transition 512 from a low-power state to a higher power state, and sends an activation signal 514 to sensor mechanism 114-1.

Moreover, sensor mechanism 114-1 performs flow measurements 516 of the flow. Furthermore, flow measurements 516 are provided to integrated circuit 116-1. In response, integrated circuit 116-1 analyzes 518 flow measurements 516. This analysis may optionally involve the use of one or more conversion tables 520, which may be received from memory 522 or from another external device (such as electronic device 138) via interface circuit 120-1. in addition, optional analysis device 118-1 may determine composition 524.

Subsequently, integrated circuit 116-1 provides results 526 of analysis 518 (such as the information associated with the flow, an error condition and/or an environmental condition) to interface circuit 120-1, and interface circuit 120-1 communicates results 526 to another electronic device, such as electronic device 138.

While the preceding example illustrated integrated circuit 116-1 performing operations in the environmental-monitoring technique, in other embodiments at least some of these operations are performed by a processor in electronic device 110-1 (i.e., at least some of the operations may be performed by software executed by the processor).

In some embodiments of one or more of the preceding methods, there may be additional or fewer operations. For example, the measurements of the flow may be mapped or converted into the information associated with the flow, the error condition and/or an associated environmental condition in method 400 (FIG. 4) using additional information, such as predefined relationship between the measurements and the flow, the error condition and/or the environmental condition. Furthermore, the order of the operations may be changed, and/or two or more operations may be combined into a single operation. In addition, in some of the preceding embodiments there are fewer components, more components, a position of a component is changed and/or two or more components are combined.

In an exemplary embodiment, the sensor mechanism includes an ultrasound transducer that generates waves in an ultrasonic band of frequencies (such as between 20,000 Hz and 2-3 GHz). The electronic device may be clamped around a pipe that conveys a fluid. An impedance-matching material (such as a gel) between the electronic device (and, in particular, the ultrasound transducer) and the pipe may reduce or prevent reflections of the ultrasonic waves generated by the ultrasound transducer at the wall or housing of the pipe. Instead, the ultrasonic waves may be reflected by the fluid. The fundamental frequency of the reflected waves may be modulated by the flow via the Doppler effect. These reflected waves may be received by the ultrasound transducer. The modulation of the fundamental frequency of the ultrasonic waves may allow a vector profile (magnitude and direction) of the flow in the pipe to be determined. Alternatively, an acoustic transducer may actively determine the flow by generating and receiving waves in an acoustic band of frequencies (such as between 20 Hz and 20,000 Hz).

Alternatively, the sensor mechanism may include a passive sensor, such as an acoustic sensor and/or a vibration sensor (which detects vibrations of the pipe at frequencies largely below a lowest resonance frequency of the pipe). The passive sensor may receive waves or vibrations in the pipe associated with the flow. These waves may be detected using a bandpass filter that excludes extraneous signals or noise. An increase in the magnitude of the received signal (after the bandpass filter) may indicate the presence of the flow. Similarly, a partial blockage of the pipe may result in turbulent flow in the pipe. This acoustic signature may be detected by an acoustic sensor and/or a vibration sensor.

The measurements performed by the sensor mechanism may facilitate leak detection and prevention. In addition, the optional analysis device may determine the composition of the fluid (such as the presence of any contaminants) and/or the material of the pipe, such as by using chemical analysis and/or microanalysis. For example, this may allow the age of the pipe or damage to the pipe to be determined. Thus, the electronic device may facilitate diagnostic or quality-control testing of the fluid or the pipe.

In some embodiments, the electronic device detects a leak signature by comparing the flow measurements and/or the composition of the pipe and/or the fluid to a data structure with an historical record of similar characteristics. For example, comparisons may be performed relative to the baseline for the pipe and/or the fluid. Alternatively or addition, a threshold value may be used. Sudden changes or changes over time may be used to detect an anomaly. Thus, the analysis performed by the electronic device may be quantitative or may involve a binary threshold (such as the presence or absence of the flow).

As noted previously, an environmental condition may be associated with the flow measurements. Consequently, the electronic device may infer or may determine the environmental condition based on the flow measurements and/or the composition of the pipe and/or the fluid. For example, the presence of a leak may be determined. Alternatively or additionally, usage of the fluid or the vessel may be determined in order to identify unauthorized usage. In some embodiments, the environmental condition is determined by comparing the measured flow to a threshold value or an accuracy (such as change in the flow of more than 10% or 1 kg·m/s). Thus, usage of a sewer line may be identified. Similarly, excessive fresh water usage may be identified and stopped. In particular, when the measured flow exceeds a threshold value (or is less than the threshold value), a switch in the electronic device may selectively electrically couple or decouple another electronic device (such as the regulator device) from a power source. In this way, a regulator device (such as a pump, a valve, etc.) may be selectively activated. Alternatively or additionally, the threshold value may be related to a medical condition of the user. Note that, while preceding discussion illustrated selective electrical coupling or decoupling based on a static or fixed preference the threshold value), more generally, the threshold value may evolve or change as a function of time or the environmental condition, which may allow the electronic device to dynamically respond to or control the environmental condition.

This monitoring and, as needed, control capability may be useful in a multi-occupancy building (such as an apartment building), where residents may share a common bill for utility, water or sewage service. For example, the electronic device may allow usage of such a common or shared resource to be monitored, so that a bill for service can be correctly apportioned or divided among the residents. In addition, usage statistics may be determined for a metered resource from a central vessel to an individual vessel.

We now further describe embodiments of the electronic device and configurations involving two or more instances of the electronic device or two or more sensors associated with an instance of the electronic device. FIG. 6 presents a drawing illustrating measurement of a now of a fluid in vessel 112. In FIG. 6, electronic device 110-1 is clamped around an external surface 610 of vessel 112. Thus, FIG. 6 illustrates measurement of the flow using non-invasive techniques (which may not involve direct contact with the fluid), such as via sound waves that penetrate through vessel 112. In addition, non-invasive techniques (such as microanalysis) may be used to assess the composition of the fluid and/or vessel 112.

However, in other embodiments sensor mechanism 114-1 at least partially penetrates through a housing of vessel 112. This is shown in FIG. 7, which presents a drawing illustrating measurement of a flow of a fluid in vessel 112. In particular, in FIG. 7 sensor mechanism 114-1 is screwed or inserted into housing 710 of vessel 112. In this embodiment, the measurements are also non-invasive. Note that housing 710 may be separate from and/or a portion of mounting mechanism 108-1.

While many of the preceding examples illustrated the environmental-monitoring technique using non-invasive techniques (and, thus, without contact between the sensor mechanism and the fluid), in other embodiments there may be contact between the sensor mechanism and the fluid. For example, the sensor mechanism may include a kinetic sensor (such as a turbine). This is shown in FIG. 8, which presents a drawing illustrating measurement of a flow of a fluid in vessel 112. In particular, sensor mechanism 114-1 may contact the fluid in vessel 112. This may allow measurements of the flow using an invasive technique (which may involve direct contact with the fluid). In addition, contact with the fluid may facilitate certain types of chemical analysis to determine the composition and/or purity of the fluid. In some embodiments, invasive or non-invasive techniques allow a risk associated with the fluid (such as an explosion hazard) to be determined.

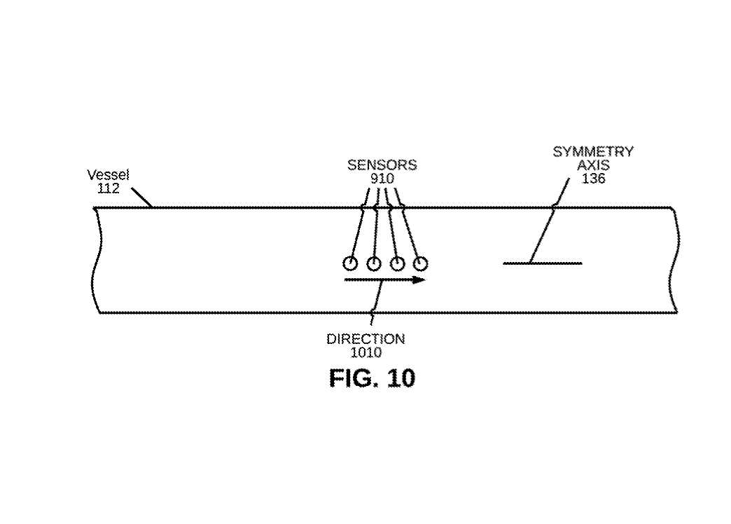

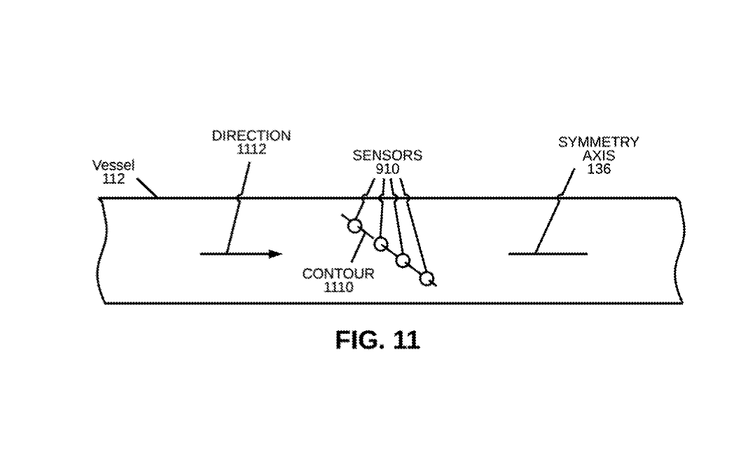

As noted previously, multiple instances of the electronic device at different locations on the vessel may communicate with each other to facilitate determination of the information associated with the flow, the error condition and/or the environmental condition. Alternatively or additionally, there may be multiple sensors at different locations on the vessel that communicate with one of the electronic devices. For purposes of illustration, the latter is shown in FIGS. 9-11 which present drawings illustrating measurement of a flow of a fluid in vessel 112. In particular, the sensor mechanism may include multiple sensors 910 that mechanically couple to the vessel along a contour on external surface 610. This contour may include: a cross-sectional contour 912 in FIG. 9 that is approximately perpendicular to a symmetry axis 136 of vessel 112; a direction 1010 in FIG. 10 that is approximately parallel to symmetry axis 136 of vessel 112; and/or a spiral contour 1110 in FIG. 11 having a symmetry axis 1112 that is approximately parallel to a symmetry axis 136 of vessel 112 (such as a helical or double helical distribution or configuration of sensors 910).

The configurations shown in FIGS. 9-11 are for purposes of illustration. In other embodiments, different configurations or topologies are used. For example, a star topology may be used, with one electronic device and many one-to-one or one-to-hub connections to the multiple sensors. In another embodiment, serial or chain-type of communication is used between the instances of the electronic device and/or the multiple sensors. In any of these embodiments, the sensors and/or the instances of the electronic device may be arranged in a mesh network in which the communication involves hoping of packets from one electronic device or sensor to an adjacent electronic device or sensor. As noted previously, the communication may be wireless, via the pipe and/or may involve vibrations in the pipe and/or the fluid (e.g., an acoustic transducer in the electronic device may transmit or receive information via the vibrations, such as those within or outside the range of human hearing). In some embodiments, unique identifiers for the sensors and/or the electronic devices are conveyed during the communication.

In some embodiments, the instances of the electronic device and/or the multiple sensors determine their relative order (such as along direction 1010 in FIG. 10) based on flow measurements over time (such as the flow magnitude and/or or the relative velocity). For example, in FIG. 10 a first one of sensors 910 may determine a change in the flow before a second adjacent sensor in sensors 910. Then, the second sensor may determine the change in the flow before the next adjacent sensor in sensors 910. In this way, sensors 910 may determine their relative order. If another sensor is added, sensors 910 can dynamically re-determine their order. Note that information about the order of sensors 910 can be used during the analysis to detect events, such as a leak, a partial blockage or a complete blockage of the vessel.

While the preceding example used the measured direction and/or magnitude of the flow to determine the relative positions of sensors 910 for a spatial map of sensor positions), in other embodiments the position information is determined, at least in part, using a local positioning system and/or a Global Positioning System. (Thus, in some embodiments, the electronic device includes a position sensor.) More generally, the location of sensors 910 (and/or multiple instances of the electronic device) may be determined using triangulation or trilateration. The location information may allow the flow in vessels to be mapped, which may allow specific vessels or pipes to be tested for leaks (e.g., based on the continuity equation). This capability may be useful in industrial applications, such as a chemical plant or an oil refinery.

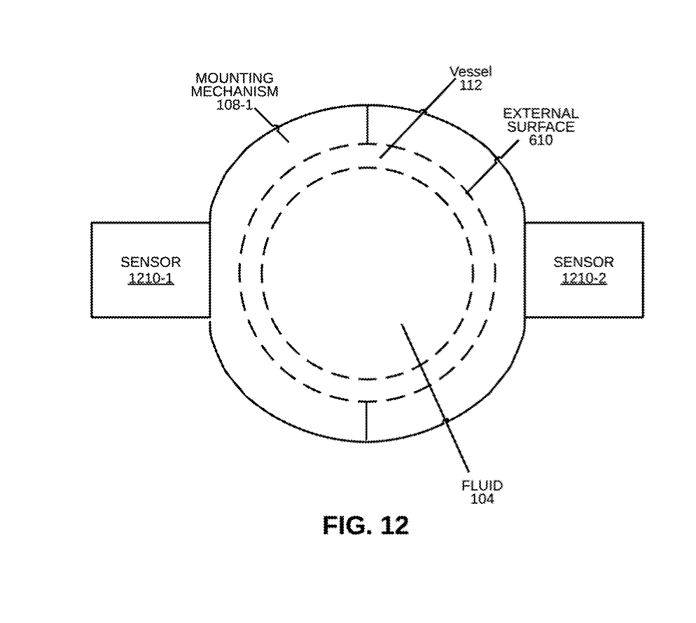

In some embodiment, the electronic device performs measurements on opposite sides of the vessel. This is shown in FIG. 12, which presents a drawing illustrating measurement of a flow of a fluid in vessel 112. In particular, sensors 1210 may allow interference to be used to measure the flow. Alternatively or additionally, sensors on opposite skies of vessel 112 may work in pairs, where, at a given time, one sensor acting as a transmitter and the other sensor as a receiver. Note that the measurements may be: optical, electrical, audio, acoustic and/or ultrasonic. As noted previously, the measurements may include: binary information (the presence or absence of the flow), a direction of the flow, a quantitative measurement of the now magnitude and/or direction and/or a flow rate. In some embodiments, the fluid composition may allow the fluid or a material being transported to be identified. In addition, if one or more sensors are positioned near an outlet from vessel 112, visual or optical inspect may be used to determine the flow rate.

Furthermore, because gravity can affect the flow in the vessel, in some embodiments the electronic device determines the orientation of the electronic device and/or one or more sensors. This is shown in FIG. 13, which presents a drawing illustrating measurement of a flow of a fluid in vessel 112 using one or more sensors 1310. For example, the orientation relative to the ground or the Earth's magnetic field may be determined and, more generally, relative to a reference direction 1312. (Note that the orientation relative to the ground or the Earth's magnetic field can be combined with detected leak information to assist in detecting, locating and/or repairing leaks.) Because the flow may only occupy a portion of cross-sectional area of vessel 112, determining the orientation may allow the material flux or quantity associated with the flow (and, more generally, a quantitative flow metric) to be determined. Thus, the cross-sectional area of fluid 104 or, as shown in FIG. 13, a cross-sectional area 1314 without fluid may be determined (either of which may specify the other cross-sectional area). In some embodiments, the electronic device determines the orientation as a function of time. This may be useful in environments where the orientation can change, such as during shipment of fluid. Additionally, the electronic device may measure acceleration (e.g., using an accelerometer), which may allow forces (such as the centripetal force) to be determined.

Furthermore, while monitored fluid was illustrated as a liquid, a gas or as having discrete particles (such as grain), in other embodiments the monitoring technique is applied to other types of fluid. For example, the ‘fluid’ may include an electrical current in a wire and/or packets of information in a communication channel. Thus, the fluid may include electromagnetic signals conveyed in a generalized vessel, such as one or more wires, a cable and, more generally, a material that conveys electromagnetic signals (such as time-varying currents, voltages and/or electromagnetic fields). In these embodiments, the sensor mechanism may include: an electromagnetic sensor, an electromotive force sensor, an inductive sensor (such as an inductive-loop sensor), a magnetic-field sensor (such as a magnetometer, a superconducting quantum interference device, etc.), and/or another sensor capable of monitoring data traffic. The monitored data flow may be used to trigger um alert or an alarm, or may be used to change the selective coupling or a switch (such as from coupled to de-coupled).

Additionally, while the previous discussion illustrated the electronic device mounted on the vessel, in other embodiments (such as those in which there are multiple instances of the sensor associated with the electronic device) the electronic device may be mounted near the vessel. For example, the electronic device may be mounted on: a wall, a cabinet, the ground/floor, an enclosure or holding tank, and/or above or near an outlet from the vessel.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a mounting mechanism configured to mechanically couple to a vessel that conveys a fluid;
a sensor mechanism configured to measure flow of the fluid in the vessel without contact with the fluid; and
an integrated circuit, electrically coupled to the sensor mechanism, configured to analyze the measurements.

2. The electronic device of claim 1, wherein the mounting mechanism includes a clamp.

3. The electronic device of claim 1, wherein the mounting mechanism includes a surface having an impedance-matching material configured to mechanically couple to the vessel.

4. The electronic device of claim 1, wherein the sensor mechanism includes one of: an ultrasound transducer, an acoustic transducer, an optical sensor, and an electrical sensor configured to detect of motion of electrically charged particles, a magnetic sensor configured to detect of motion of mimetic particles, a Hall-effect sensor, a vibration sensor, a sensor that measures a parameter that is a function of temperature, and a pressure sensor.

5. The electronic device of claim 1, wherein the mounting mechanism is configured to mechanically couple to an exterior of the vessel.

6. The electronic device of claim 1, wherein the mechanical coupling involves screwing the mounting mechanism into the vessel.

7. The electronic device of claim 1, further comprising an analysis device configured to determine a composition of the fluid.

8. The electronic device of claim 1, wherein the sensor mechanism includes multiple sensors configured to mechanically couple to the vessel along a contour; and
wherein the contour includes one of: a cross-sectional contour that is approximately perpendicular to a symmetry axis of the vessel; a direction that is approximately parallel to a symmetry axis of the vessel; and a spiral contour having a symmetry axis that is approximately parallel to a symmetry axis of the vessel.

9. The electronic device of claim 1, further comprising an interface circuit configured to communicate with other instances of the electronic device that are mechanically coupled to the vessel.

10. The electronic device of claim 9, wherein the electronic device is electrically coupled to the vessel; and
wherein the communication occurs via the vessel.

11. The electronic device of claim 9, wherein the communication occurs via the fluid.

12. The electronic device of claim 1, further comprising: a power supply configured to receive and to store power based on the flow.

13. The electronic device of claim 12, wherein the power supply includes one of: a turbine, a power source based on vibration associated with the flow, a power source based on a temperature difference associated with the flow, a power source based on a flow of magnetic particles, and a power source based on a flow of electrically charged particles.

14. The electronic device of claim 1, wherein the fluid includes one of: a liquid, a gas, and discrete particles.

15. The electronic device of claim 1, wherein the measured flow includes information specifying: a presence or absence of the flow, a direction of the flow, a speed of the flow, identification of the fluid, a material flux of the flow, measurement of the quality of a vacuum and presence or absence of turbulence.

16. The electronic device of claim 1, wherein the sensor mechanism is further configured to determine one of: an orientation of the sensor mechanism relative to a reference direction; and a cross-sectional area of the flow in the vessel.

17. A system comprising multiple instances of an electron e device that are mechanically coupled to a vessel that conveys a fluid at different positions on the vessel, wherein a given instance of the electronic device includes:
a mounting mechanism configured to mechanically couple the given instance of the electronic device to the vessel;
a sensor mechanism configured to measure flow of the fluid in the vessel without contact with the fluid;
an integrated circuit, electrically coupled to the sensor mechanism, configured to analyze the measurements; and
an interface circuit, electrically coupled to the integrated circuit, configured to communicate with one or more of the multiple instances of the electronic device.

18. The system of claim 17, wherein the communication includes information about flow measurements obtained by the one or more of the multiple instances of the electronic device
wherein the integrated circuit is configured to determine a relative order of the given instance of the electronic device and the one or more of the multiple instances of the electronic device based on the communication.

19. The system of claim 17, wherein the integrated circuit is configured to identify an error condition in the vessel based on at least one of historical measurements of the flow; and information about flow measurements obtained by the one or more of the multiple instances of the electronic device; and
wherein the error condition includes: a partial blockage of the vessel, complete blockage of the vessel, a leak, unauthorized usage of the fluid, and a malfunctioning sensor mechanism.

20. An electronic-device-implemented method for measuring flow of a fluid in a vessel, wherein the method comprises:
receiving a wake signal from another instance of the electronic device at another position along the vessel when the other instance of the electronic device detects the presence of the flow;
transitioning the electronic device from a low-power state to a higher power state based on the received wake signal;
measuring the flow using a sensor mechanism in the electronic device; and
analyzing the measurements using an integrated circuit in the electronic device.
